(19) United States
(12) Patent Application Publication
(10) Pub. No.: US 2015/0161013 A1
(43) Pub. Date: Jun. 11, 2015

(54) DATA RECOVERY METHOD AND SYSTEM

(71) Applicant: BEIJING NETQIN TECHNOLOGY CO., LTD., Beijing (CN)

(72) Inventors: Lin Cheng, Beijing (CN); Tao Liang, Beijing (CN); Zheng Zhao, Beijing (CN); Ping Cheng, Beijing (CN)

(21) Appl. No.: 14/414,951

(22) PCT Filed: Mar. 14, 2013
(86) PCT No.: PCT/CN2013/072622

§ 371 Date: Jan. 15, 2015

(30) Foreign Application Priority Data
Jul. 30, 2012 (CN) 201210268523.5

(51) Int. Cl. G06F 11/14

(52) U.S. Cl. CPC G06F 11/1464; G06F 11/1451; G06F 11/1453

(57) ABSTRACT

The present disclosure provides a data recovery method comprising: A. receiving a data type of data which is selected by a user to be recovered; B. detecting a first capacity of data having the same data type on a server side, detecting a second residual capacity of a local storage of a mobile terminal, and comparing the first capacity with the second capacity, wherein if the first capacity is greater than the second capacity, the recovery process is interrupted, and if the first capacity is not greater than the second capacity, step C is performed; and C. downloading the data to be recovered from the server side to mobile terminal for recovery, and displaying a recovery result after the recovery is completed. With the present disclosure, recovery of a large amount of data can be achieved by recovering the data from the server side, thereby not only reducing the amount of local computations at the mobile terminal and reducing resource consumption, but also better protecting the important data from being lost, which is convenient to use.

### CROSS-REFERENCE TO RELATED APPLICATION(S)

This application is a U.S. National Phase Application of International Application No. PCT/CN2013/072622, filed on Mar. 14, 2013, entitled “DATA RECOVERY METHOD AND SYSTEM,” which claims priority to Chinese Application No. 201210268523.5, filed on Jul. 30, 2012, both of which are incorporated herein by reference in their entirety.

### TECHNICAL FIELD

The present disclosure relates to the field of mobile terminals, and in particular, to a data recovery method and system.

### BACKGROUND

With the frequent use of mobile terminals, such as smart phones, tablets, etc., people increasingly rely on them. A user surfs the Internet, receives and sends emails, chats, or stores some important personal information including information such as photos, important contacts, etc. through a mobile phone or a tablet. Currently, users are used to back up the important information in a local device, and perform data recovery locally. Such operations will increase amount of local computations, and consume a large amount of resources. In addition, such operations may cause original data to be overwritten when data is recovered. Thereby, the original data content cannot be recovered, or even lost.

### SUMMARY

In view of above, an object of the present disclosure is to provide a data recovery method for providing mobile terminal data with a method of recovering data from a server side, thereby satisfying users' requirements for security.

The present disclosure provides a data recovery method comprising:

A. receiving a data type of data which is selected by a user to be recovered;

B. detecting a first capacity of data having the same data type on a server side, detecting a second residual capacity of a local storage of a mobile terminal, and comparing the first capacity with the second capacity, wherein if the first capacity is greater than the second capacity, the recovery process is interrupted, and if the first capacity is not greater than the second capacity, step C is performed; and

C. downloading the data to be recovered from the server side to the mobile terminal for recovery, and displaying a recovery result after the recovery is completed.

According to the above method, the data type comprises any one of image, video, short message, call record, and personal contact, or any combination thereof, a personal contact comprising a contact name, a telephone number, and a personal incoming call processing manner.

According to the above method, the server side receives from the mobile terminal an instruction of requesting for downloading the data to be recovered, and transmits to the mobile terminal the data to be recovered.

According to the above method, the method further comprises: after the recovery process is interrupted, if the user chooses to continue the recovery, continuing the recovery from a point where the data has been recovered.

According to the above method, the method further comprises: processing, by the mobile terminal, the downloaded data to be recovered by:

combining, de-duplicating, encrypting, and storing data having the image type and/or the video type; and

unpacking, combining, de-duplicating, packing, encrypting, and storing data having the short message type, the call record type, and/or the personal contact type.

The present disclosure provides a data recovery system comprising a display module, the system further comprising: a mobile terminal comprising an acquisition module, a detection and processing module, and a download and recovery module; and a server side, wherein

the acquisition module is configured to receive a data type of data which is selected by a user to be recovered;

the detection and processing module is configured to detect a first capacity of data having the same data type on the sever side, detect a second residual capacity of a local storage of the mobile terminal, and compare the first capacity with the second capacity, wherein if the first capacity is greater than the second capacity, the recovery process is interrupted, and if the first capacity is not greater than the second capacity, a download and recovery operation is performed by the download and recovery module; and

the download and recovery module is configured to download the data to be recovered from the server side to the mobile terminal for recovery; and

the display module is configured to display a recovery result after the recovery is completed.

According to the above system, the data type comprises any one of image, video, short message, call record, and personal contact, or any combination thereof, a personal contact comprising a contact name, a telephone number, and a personal incoming call processing manner.

According to the above system, the server side comprises a processing module configured to receive from the mobile terminal an instruction of requesting for downloading data to be recovered, and transmit to the mobile terminal the data to be recovered.

According to the above system, the system is further configured to continue the recovery from a point where the data has been recovered if the user chooses to continue the recovery after the recovery process is interrupted.

According to the above system, the mobile terminal further comprises a combination and processing module configured to process the downloaded data to be recovered by:

combining, de-duplicating, encrypting, and storing data having the image type and/or the video type; and

unpacking, combining, de-duplicating, packing, encrypting, and storing data having the short message type, the call record type, and/or the personal contact type.

Compared with the conventional technologies, with the data recovery method and system according to the present disclosure, recovery of a large amount of data can be achieved by recovering the data from the server side, thereby not only reducing the amount of local computations at the mobile terminal and reducing the resource consumption, but also better protecting the important data from being lost, which is convenient to use.

### BRIEF DESCRIPTION OF THE DRAWINGS

In order to illustrate technical solutions in embodiments of the present disclosure or in the prior art more clearly, drawings needed to be used in the description of the embodiments or the prior art will be described below in brief. Obviously, the drawings described below are merely some embodiments of the present disclosure. Those ordinarily skilled in the art can further contemplate other drawings from these drawing without any inventive efforts. In the drawings:

FIG. 1 is a flowchart of a data recovery method according to an embodiment of the present disclosure;

FIG. 2 is a diagram of a display interface of a mobile terminal according to an embodiment of the present disclosure;

FIG. 3 is a flowchart of a data recovery operation of a mobile terminal according to an embodiment of the present disclosure; and

FIG. 4 is a block diagram of a data recovery system of a mobile terminal according to an embodiment of the present disclosure.

### DETAILED DESCRIPTION

In order to make the objects, technical solutions and advantages of the present disclosure more clear, embodiments of the present disclosure will be further described in detail below in conjunction with accompanying drawings. The illustrative embodiments of the present disclosure and the description thereof are used to explain the present disclosure, instead of limitations to the present disclosure.

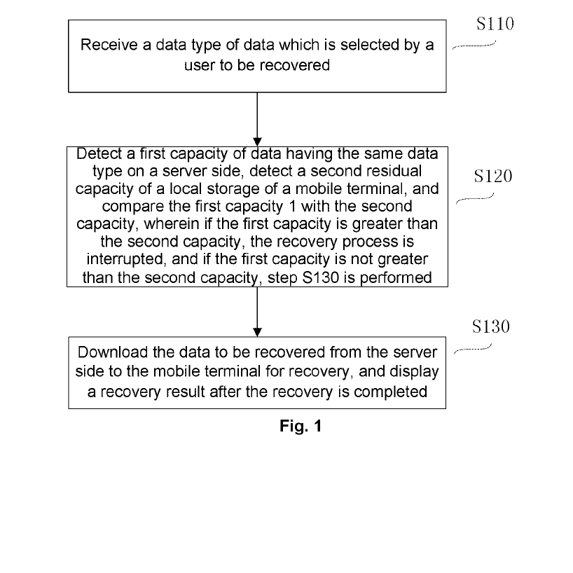

With reference to FIG. 1, illustrated is a data recovery method according to an embodiment of the present disclosure, the method comprising following steps.

Step S110: a data type of data which is selected by a user to be recovered is received.

Step S120: a first capacity of data having the same data type on a server side is detected, a residual second capacity of a local storage of the mobile terminal is detected, and the first capacity is compared with the second capacity, wherein if the first capacity is greater than the second capacity, the recovery process is interrupted, and if the first capacity is not greater than the second capacity, step S130 is performed.

Step S130: the data to be recovered is downloaded from the server side to the mobile terminal for recovery, and a recovery result is displayed after the recovery is completed.

In the present embodiment, the use of the above data recovery method on a user's personal information takes precedence. That is, the recovery function can only be used after a user is authorized and properly logs in.

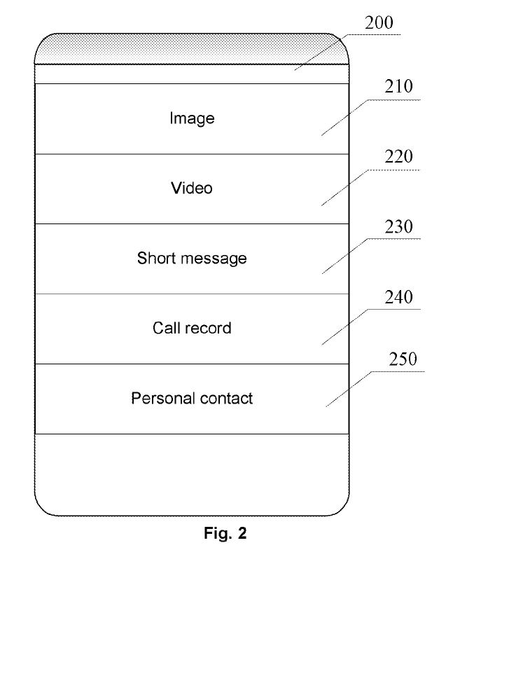

With reference to FIG. 2, illustrated is a diagram of a display interface of a mobile terminal according to an embodiment of the present disclosure. The mobile terminal could be any device, which includes but not limited to a mobile phone, a tablet, a notebook computer, etc. There are several options on a display interface 200, such as 210, 220, 230, 240, and 250, etc. Data types represented by these options comprise but not limited to image, video, short message, call record, and/or personal contact, etc. Content of a file having the image type includes the image file per se, as well as a file name, an original path, time attributes, and/or tag attributes, etc.; content of a file having the video type includes the video file per se, as well as a file name, an original path, time attributes, and/or tag attributes, etc.; content of a file having the short message type includes a telephone number, short message content, a short message type (transmission or reception), and/or a transmission or reception time, etc.; content of a file having the call record type includes a telephone number, a type (an incoming call, an outgoing call, a missed call, a rejected call, and/or a rejection manner), time, and/or a duration, etc.; and content of a file having the personal contact type includes a contact name, a telephone number(s), and/or a personal incoming call processing manner.

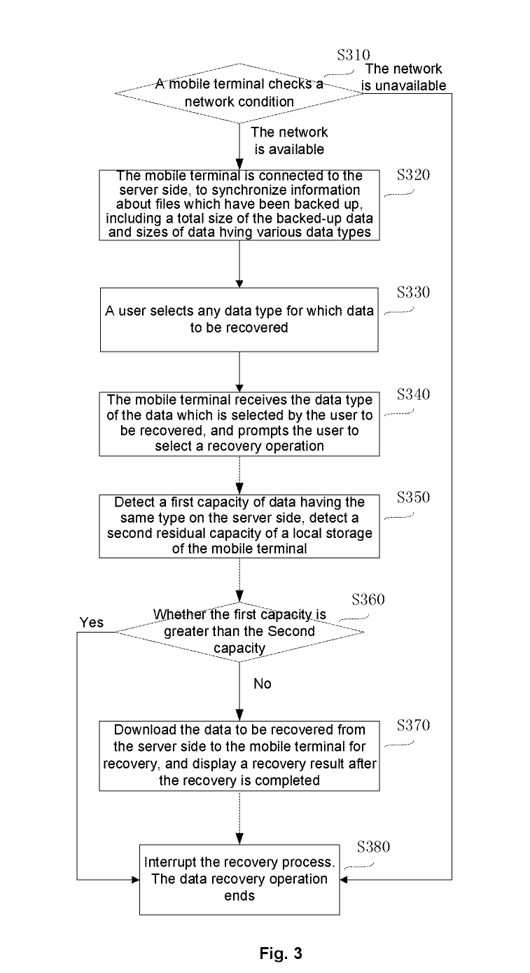

With reference to FIG. 3, when a user needs to perform a data recovery on data corresponding to any option on the display interface 200, a flow of a data recovery operation according to an embodiment of the present disclosure is described as follows.

It should be noted that before an operation of selecting a data type for data recovery, the mobile terminal needs to perform network check and networking operations as follows.

Step S310: the mobile terminal first checks its network condition. The mobile terminal recovers the data from the server side preferentially through a WiFi network. If the WiFi network is unavailable, the mobile terminal needs to prompt the user that the WiFi network is unavailable, and inquire of the user about whether to recover the data through a data network. If the data network is also unavailable, then the recovery process is interrupted, and step S370 will be performed.

Step S320: the mobile terminal is connected to the server side, to synchronize information about files which have already been backed up, including a total size of the backed-up data and sizes of data having various data types.

Step S330: data type options, including sizes for various data types, suitable for data recovery is displayed on the display interface 200 and the user selects any data type for which data is to be recovered. The user may click the data type options by using a mouse, a keyboard, and/or a touch screen, etc. In the selection process, the user can only select the types, rather than a single picture, a single video, a single contact, or a single short message, etc.

Step S340: the mobile terminal receives the data type of the data which is selected by the user to be recovered, and the user prompted to select a recovery operation.

Step S350: a first capacity of data having the same data type on the server side as the data type selected by the user is detected, and a second residual capacity of a local storage of the mobile terminal is detected.

The server side needs to firstly process the data which is selected by the user to be recovered. With respect to files having the image type and/or the video type, a processing method is as follows. Information about files which have been backed up is synchronized, and sizes of the files which already exist locally are not counted in the first capacity and these files are not downloaded, wherein the existing files refer to files with the same File IDs. With respect to files having the short message type, the call record type, and the personal contact type, all of them are packed into a data package. In other words, the first capacity is a size of data having the selected data types in the data which has been backed up by the user and which is to be acquired from the server side.

Step S360: the first capacity is compared with the second residual capacity of the local storage to determine whether the first capacity is greater than the second capacity, and if so, the recovery process is interrupted, and step S380 is performed; otherwise, step S370 is performed.

Step S370: the data to be recovered is downloaded from the server side to the mobile terminal for recovery, and a recovery result is displayed after the recovery is completed.

The server side receives from the mobile terminal an instruction of requesting for downloading data to be recovered, and transmits to the mobile terminal the data to be recovered.

In this embodiment, the data on the server side is encrypted and stored, and therefore before the data is downloaded, it needs to decrypt the data. The data having the short message type, the call record type and/or the personal contact type is decrypted into a data package. In the process of downloading and transmitting the data, the data to be transmitted may be encrypted through an HTTPS protocol. After the downloaded data is received by the mobile terminal, the mobile terminal needs to process and store the data.

With respect to a file having the image type and/or the video type, a processing approach is as follows. The information about the files which have been backed up on the server side is synchronized to the mobile terminal. The same files which exist locally will not be recovered, and will not be counted in a size of data to be downloaded. In this embodiment, uniqueness of a file is determined based on its MD5 value and its original path. If two files have a same MD5 value but different original paths, the files should be considered as different files, and should be counted into the recovery capacity and be downloaded for recovery, and the mobile terminal encrypts and stores the combined data to in a self-built database.

With respect to a file having the short message type and the call record type, a processing approach is as follows. The mobile terminal downloads, combines and de-duplicates all data having a same type. Only if all fields in two short messages or call records are same, they are considered to be same. For a short message and/or a call record, any difference in any field indicates a different record.

With respect to a file having the personal contact type, a processing approach is as follows. The mobile terminal downloads, combines and de-duplicates all data having the same type. Combining rules are as follows:

if two contacts have a same name and a same telephone number, they are considered as a same contact, and no recovery is performed and the original contact is retained;

if two contacts have a same name but different telephone numbers, a new personal contact is created; and

if two contacts have different names but a same telephone number, the original contact with the same number is overwritten.

It should be noted that with respect to a data package having the short message type, the call record type, and the personal contact type which is packed and transmitted by the server side, the data package is first unpacked by the mobile terminal into original data, and is combined and de-duplicated together with existing data having the same type in the mobile terminal, and then the mobile terminal packs, encrypts, and stores the combined data in the self-built database.

In the recovery process, the recovery process may be cancelled by the user at any time. For example, the recovery process may be cancelled by clicking on a cancel button or clicking on a return key. If a part of files have been recovered, after the cancellation, a result of a size of data which has been recovered should be displayed. A situation where a part of a file has been successfully recovered does not exist. In addition, as the data having the short message type, the call record type, and the personal contact type is packed and then recovered as a whole, the packed data should be considered as one file.

In the recovery process, breakpoint resume is supported. If the user cancels the recovery process or the recovery process is interrupted temporarily due to network conditions, the recovery process should be paused. If the user chooses to continue the recovery, the recovery continues from a point at which the data has just been recovered, rather than starting from the very beginning. There is no need to support breakpoint resume for a single file.

In the recovery process, if the user presses the HOME key to switch to another application program, the recovery process will not be interrupted. When it is switched back to the recovery operation, the recovery process should still be displayed.

After the data has been downloaded and recovered completely, a recovery result is displayed by the mobile terminal. It is only needed to display sizes for various data types, without displaying a specific number of files which have been recovered.

Step S380: the recovery process is interrupted, and the data recovery operation ends.

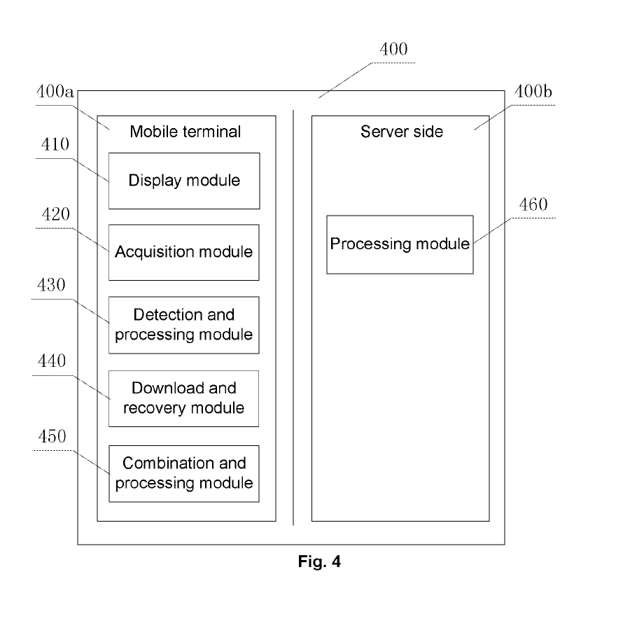

With reference to FIG. 4, illustrated is a block diagram of a data recovery system 400 according to this embodiment. The system 400 includes a mobile terminal 400a and a server side 400b. The mobile terminal 400a includes a display module 410 configured to display a recovery result after the recovery is completed; an acquisition module 420 configured to receive a data type of data which is selected by a user to be recovered; a detection and processing module 430 configured to detect a first capacity of data having the same data type on the server side 400b, detect a second residual capacity of a local storage of the mobile terminal 400a, and compare the first capacity with the second capacity, wherein if the first capacity is greater than the second capacity, the recovery process is interrupted, and if the first capacity is not greater than the second capacity, a download and recovery operation is performed by a download and recovery module 440; and the download and recovery module 440 configured to download the data to be recovered from the server side 400b to the mobile terminal 400a for recovery.

The server side 400b includes a processing module 460 configured to receive from the mobile terminal 400a an instruction of requesting for downloading the data to be recovered, and transmit to the mobile terminal 400a the data to be recovered.

With respect to a file having the image type and/or the video type, the mobile terminal 400a is connected to the server side 400b, and the acquisition module 420 may acquire and synchronize from the server side 400b information about files which have been backed up, wherein the information includes a total size of the data which has been backed up and sizes of data having various data types.

The data of the server side 400b is encrypted and stored, and therefore before the data to be recovered is downloaded for recovery, the processing module 460 needs to decrypt the data, wherein the data having the short message type, the call record type, and the personal contact type is decrypted into a data package. In the process of downloading and transmitting the data, the data to be transmitted is encrypted by the processing module 460 through an HTTPS protocol.

In this embodiment, data types which may be selected by the user include but not limited to image, video, short message, call record, and/or personal contact. A personal contact includes a contact name, a telephone number(s), and a personal incoming call processing manner.

The system 400 is further configured to continue the recovery from a point at which the data has just been recovered if the user chooses to continue the recovery after the recovery process is interrupted. In an embodiment of the present disclosure, breakpoint resume is supported in the recovery process. If the user cancels the recovery process or the recovery process is interrupted temporarily due to network conditions, the recovery process should be paused. If the user chooses to continue the recovery, the recovery continues from a point at which the data has just been recovered, rather than starting from the very beginning. There is no need to support breakpoint resume for a single file.

The mobile terminal 400a further comprises a combination and processing module 450 configured to process the downloaded data to be recovered.

For example, with respect to a file having the image type and/or the video type, a processing approach is as follows. The information about the files which have been backed up on the server side 400b is synchronized to the mobile terminal 400a. The combination and processing module 450 will not recover the files which exist locally, and will not count the files in a size of data to be downloaded. In this embodiment, uniqueness of a file is determined based on its MD5 value and its original path. If two files have a same MD5 value but different original paths, the files should be considered as different files, and should be counted into the recovery capacity and be downloaded for recovery, and the combination and processing module 450 encrypts and stores the combined data in a self-built database.

With respect to a file having the short message type and the call record type, a processing approach is as follows. The combination and processing module 450 performs combination and de-duplication processes. Only if all fields in two short messages or call records are same, they are considered to be same. For a short message and/or a call record, any difference in any field may indicate a different record.

With respect to a file having the personal contact type, a processing approach is as follows. The combination and processing module 450 performs combination and de-duplication processes. Combining rules are as follows:

if two contacts have a same name and a same telephone number, they are considered as the same contact, and no recovery is performed and the original contacts is retained;

if two contacts have a same name but different telephone numbers, a new personal contact is created; and

if two contacts have different names but a same telephone number, the original contact with the same number is overwritten.

It should be noted that with respect to the data package having the short message type, the call record type, and the personal contact type which is packed and transmitted by the server side 400b, the data package is first unpacked by the combination and processing module 450 into original data, and is combined and de-duplicated together with existing data having the same types in the mobile terminal 400a, and then the combination and processing module 450 packs, encrypts, and stores the combined data in the self-built database.

The above specific embodiments further describe the objects, technical solutions and beneficial effects of the present disclosure in detail. It should be understood that the above description is merely specific embodiments of the present disclosure, rather than limitations to the scope of the present disclosure. Any modification, equivalent substitution, improvement etc., made within the spirit and principle of the present disclosure, should be included in the scope of the present disclosure.

1. A data recovery method, comprising:
A. receiving a data type of data which is selected by a user to be recovered;
B. detecting a first capacity of data having the same data type on a server side, detecting a second residual capacity of a local storage of a mobile terminal, and comparing the first capacity with the second capacity, wherein if the first capacity is greater than the second capacity, the recovery process is interrupted, and if the first capacity is not greater than the second capacity, step C is performed; and
C. downloading the data to be recovered from the server side to the mobile terminal for recovery, and displaying a recovery result after the recovery is completed.

2. The method according to claim 1, wherein the data type comprises any one of image, video, short message, call record, and personal contact, or any combination thereof, a personal contact comprising a contact name, a telephone number, and a personal incoming call processing manner.

3. The method according to claim 1, wherein the server side receives from the mobile terminal an instruction of requesting for downloading data to be recovered, and transmits to the mobile terminal the data to be recovered.

4. The method according to claim 1, further comprising: after the recovery process is interrupted, if the user chooses to continue the recovery, continuing the recovery from a point where the data has been recovered.

5. The method according to claim 2, further comprising: processing, by the mobile terminal, the downloaded data to be recovered by:
combining, de-duplicating, encrypting, and storing data having the image type and/or the video type; and
unpacking, combining, de-duplicating, packing, encrypting, and storing data having the short message type, the call record type, and/or the personal contact type.

6. A data recovery system comprising a display module, the system further comprising: a mobile terminal comprising an acquisition module, a detection and processing module, and a download and recovery module; and a server side, wherein
the acquisition module is configured to receive a data type of data which is selected by a user to be recovered;
the detection and processing module is configured to detect a first capacity of data having the same data type on the sever side, detect a second residual capacity of a local storage of the mobile terminal, and compare the first capacity with the second capacity, wherein if the first capacity is greater than the second capacity, the recovery process is interrupted, and if the first capacity is not greater than the second capacity, a download and recovery operation is performed by the download and recovery module; and
the download and recovery module is configured to download the data to be recovered from the server side to the mobile terminal for recovery; and
the display module is configured to display a recovery result after the recovery is completed.

7. The system according to claim 6, wherein the data type comprises any one of image, video, short message, call record, and personal contact, or any combination thereof, a personal contact comprising a contact name, a telephone number, and a personal incoming call processing manner.

8. The system according to claim 6, wherein the server side comprises a processing module configured to receive from the mobile terminal an instruction of requesting for downloading data to be recovered, and transmit to the mobile terminal the data to be recovered.

9. The system according to claim 6, wherein the system is further configured to continue the recovery from a point where the data has been recovered if the user chooses to continue the recovery after the recovery process is interrupted.

10. The system according to claim 7, wherein the mobile terminal further comprises a combination and processing module configured to process the downloaded data to be recovered by:
combining, de-duplicating, encrypting, and storing data having the image type and/or the video type; and
unpacking, combining, de-duplicating, packing, encrypting, and storing data having the short message type, the call record type, and/or the personal contact type.
